(19) United States
(12) Patent Application Publication
(10) Pub. No.: US 2022/0117715 A1
(43) Pub. Date: Apr. 21, 2022

(54) Pet hip brace system

(71) Applicant: Renee Mills, Mount Airy, MD (US)

(72) Inventor: Renee Mills, Mount Airy, MD (US)

(21) Appl. No.: 17/422,843

(22) PCT Filed: Jan. 15, 2019
(86) PCT No.: PCT/US2019/013583

§ 371 Date: Jul. 14, 2021

(51) Int. Cl. A61D 9/00

(52) U.S. Cl. CPC A61D 9/00

(57) ABSTRACT

A four-legged animal hip brace system (10) includes a forward harness (90), a right rear leg hip panel (20), a right leg strap (21) connected to a right panel distal end (24) and capable of encircling a right rear leg, a left rear leg hip panel (50) complementary to the right rear leg hip panel (20), a left leg strap (51) connected to a left panel distal end (54) and capable of encircling a left rear leg, a panel tether (80) between the forward harness (90) and one of a right panel proximal end (22) and a left panel proximal end (52), and at least one of a hip bridge (100) and a hip donut (120) wherein each of the hip bridge (100) and the hip donut (120) is removably attachable to one of a right panel inner surface (28) and a left panel inner surface (58).

### BACKGROUND OF THE INVENTION

### 1. Field of the Invention

The present invention relates generally to a support device suitable for use in the treatment of pet hip disorders, deformities, trauma and/or post-surgical procedures.

### 2. Description of the Prior Art

In canines and animals of similar skeletal structure, various ailments can affect the animal's hips. Among these include arthritis, hip dysplasia, conformational deformities, trauma and/or post-surgical procedures. The most common ailment is hip dysplasia. Dysplasia is considered to be a genetically predisposed condition resulting from improper growth of the joint components. This condition can drastically reduce a pet's quality of life and is painful.

There are several factors that lead to the development of hip dysplasia in canines. It is hereditary and is especially common in large and giant breed dogs, although it can occur in smaller breeds as well. Excessive growth of the animal may be attributed to the animal's nutrition and such growth can lead to skeletal disorders like hip dysplasia along with elbow dysplasia and other joint conditions. Obesity is another factor. Obesity places a lot of stress on the animal's joints, which can cause hip dysplasia or exacerbate a pre-existing condition like hip dysplasia.

Some animals begin to show signs of this disease as young as four months old. Other animals develop it in conjunction with osteoarthritis as they age. In both cases, there are several symptoms associated with hip dysplasia and these symptoms vary depending on the severity of the disease, the level of inflammation, the degree of looseness in the joint, and the length of time the animal/pet has suffered from the disease. The symptoms include decreased activity (i.e. the animal becomes lethargic), decreased range of motion, difficulty or reluctance in rising, jumping, running, or climbing stairs, lameness in the hind end, looseness in the joint, narrow stance, swaying gait, grating in the joint during movement, loss of thigh muscle mass, noticeable enlargement of the shoulder muscles as they compensate for the hind end, pain, and stiffness. Inactivity, however, exasperates hip dysplasia. The difficulty is trying to entice the animal/pet to exercise due to the pain. Minimizing the pain allows more conservative treatment to be aggressively pursued thereby potentially eliminating surgical or drug related intervention. Unfortunately, the most effective way to accomplish this goal is unattractive to the animal due to hip pain.

There are several treatment options for hip-related diseases and conditions ranging from lifestyle modifications to surgery. These options include weight reduction to remove the stress off of the hips, exercise restriction especially on hard surfaces, physical therapy, anti-inflammatory medications, and joint fluid modifiers. The surgical options include double or triple pelvic osteotomy, femoral head ostectomy, or total hip replacement. As with any medical procedure, it is the desire of the veterinarian to minimize the necessity for medication and surgery whenever possible.

### SUMMARY OF THE INVENTION

Another treatment option for treating canines and animals with similar skeletal structure issues is a prosthetic device designed for decreasing the symptoms associated with hip dysplasia. One such device is disclosed is U.S. Pat. No. 6,880,489 (2005, Hartmann et al.). The device includes a harness attachable to the canine, complementary rear braces that include a right rear brace and a left rear brace, a tether between the harness and the complementary rear braces to draw the right brace and the left brace forward, a right leg strap connected to the right rear brace for encircling the leg of the canine, and a left leg strap connected to the left rear brace for encircling the leg of the canine. The right brace and the left brace are engageable to apply force to persuade the hip towards a natural position.

Unfortunately, this device is limited in its use to hip dysplasia and lumbrosacral disorder. Lubrosacral disorder is a disease that occurs at the lumbosacral junction in the lower back. The term lumbo refers to the lumbar vertebrae. These are the bones in the lower part of the spinal column. The term sacral refers to the sacrum, which is the part of the spine that joins the lumbar spine and the pelvis. The disadvantage of the prosthetic device described in the '489 patent is that it provides even pressure across the entire hip joint, which isn't point specific and doesn't help in preventing the healing of pressure sores or ulcers directly affecting the hip joint and surrounding tissues. It also cannot be used if an amputation procedure on the hind leg of the animal was performed or on an animal affected by hind leg crossing, which can be the result of the animal suffering from hind leg weakness, neurological disease, stroke, spinal compression, or a post-surgical procedure.

It is an object of the present invention to provide a pet hip brace system that is usable for treating a greater variety of hip-related problems caused by various diseases or other neurological and spinal conditions.

The present invention achieves these and other objectives by providing an animal hip brace system to support the hip joint of pets. Pets (i.e. four-legged animals) suffering from arthritis, hip dysplasia, conformational deformities, trauma and/or post-surgical procedures benefit from the hip brace system of the present invention. The system is a multi-module support device that includes five separate attachments. The attachments may be interchanged or added as the case may be to accommodate a range of deficits affecting the hip joint (coxo-femoral joint) in four-legged animals. The hip brace system is positioned over the hip joint of the four-legged animal where the hip brace system applies pressure directly on top of the hip joint and pushes inward on the joint.

The hip brace system is constructed of a neoprene material shaped to conform to the hind leg and to secure above the stifle (knee) on each leg. The hip brace system includes a left and right rear leg hip panel that attaches to each other using a hook and loop fastener for easy adjustment to thereby locate the connection point of the hip panels on top of the pelvis. A panel tether extends transversely from one of the rear leg hip panels. The panel tether, slides through a D-ring or other formed loop of a pet harness and then attaches to itself using a fastener such as a hook and loop fastener, a snap fastener, a belt and buckle fastener, and the like. This feature aides in securing the hip brace system in place and allows for length adjustment that allows the connection point of the left and right leg pieces to be positioned directly over the pelvis. At the bottom of each left and right rear leg hip panel there is a stretchable strap of hook and loop fastener that wraps around the inside of the pet's thigh and then attaches to the rear leg hip panel to secure the respective rear leg hip panel to the respective rear leg of the four-legged animal. The stretchable strap allows for fitting legs having different leg circumferences. Each side of the left and right rear leg hip panel is preferably constructed of a neoprene material which allows hook and loop fasteners to stick to both sides for placement of attachments and to secure the straps. Although other fastening systems may be used, the hook and loop fasteners are best suited for quick and easy adjustment.

In one embodiment, the right rear leg hip panel has the panel tether that extends transversely from the right rear leg hip panel and slides through the O-ring of the pet harness and then attaches to itself. The panel tether is made of a weave or non-weave material such as, for example, webbing (e.g. nylon webbing), leather, and the like. This feature aides in securing the hip panels in place and allows for length adjustment and to position the hip brace system directly over the pelvis. It is noted that the panel tether could be attached to the left rear leg hip panel instead of the right rear leg hip panel to accomplish the same feature.

The hip support system with all the attachments has six main functions. The six main functions are a hip support device, a hip subluxation support brace, a hip pressure sore/ulcer support brace, a left rear leg support brace with a pouch for a stump of a left amputated leg, a right rear leg support brace with a pouch for a stump of a right amputated leg, and a rear leg anti-crossing support brace.

The attachments include a hip bridge, a hip donut, a left rear leg hip panel with a pouch for a stump of an amputated left rear leg, a right rear leg hip panel with a pouch for an amputated right rear leg, and a cross brace assembly.

The hip bridge is specially designed foam bridge shaped to conform directly over the hip (i.e. coxo-femoral) joint. The hip bridge has somewhat of a U-shape where the hip joint is positioned directly within the recess at the base of the U-shape between the legs of the U-shape. The hip bridge places pressure directly on the top of the joint and pushes inward on the joint when the hip support system is attached to the four-legged animal. The pressure aides in keeping the coxo-femoral joint from subluxating out of place when a four-legged animal is standing or moving. The hip bridge allows for individual placement since the hip bridge is removably attached directly to the inner surface of a left or right rear leg hip panel. This feature permits a custom fit over the coxo-femoral joint based on a pet's anatomy. The hip bridge is best used as an aide for a pet/four-legged animal suffering from mild to moderate hip subluxation.

The hip donut is a specially designed foam circle with a hole in the center to fit directly over the hip (coxo-femoral) joint. The hip donut allows pressure and weight to be distributed directly onto the hip joint and surrounding areas when a pet/four-legged animal is in a laying down position. This allows for the prevention and healing of pressure sores or ulcers directly affecting the hip joint and surrounding tissues. Like the hip bridge, the hip donut allows for individual placement since the hip donut is removably fastened directly to the inner surface of a left or right rear leg panel. This feature allows a custom fit over the coxa-femoral joint based on a pet's anatomy.

The left rear leg panel for a stump of an amputated left leg is a left rear leg hip panel with a panel pouch that is constructed of the same neoprene material. It's designed to support the remaining portion of the leg or “stump” above the knee (stifle) remaining after an amputation procedure. The left rear leg hip panel has a pocket (i.e. the panel pouch) on the inside for the stump to slide into. The pocket is constructed of a stretchable, breathable neoprene to provide a comfortable fit. The top inside of the pocket has a band of stretchable elastic lined with a soft material to allow a range of leg circumferences to fit in the pocket without any rubbing irritation to the leg. A single panel pouch strap is used to wrap around the inside of the leg stump and then attaches to the left rear leg hip panel to secure the left rear leg hip panel to the left rear leg stump of the four-legged animal. The stretchable pouch strap allows for fitting stumps having different stump circumferences. The pouch strap may be used to secure anywhere on the left rear leg hip panel to provide a customized fit. The left rear leg hip panel then attaches to a right rear leg hip panel over the pelvis so that the hip brace system is secure on the pet/four-legged animal.

The right rear leg panel is a right rear leg hip panel with a panel pouch that is constructed of the same neoprene material. It's designed to support the remaining portion of leg or “stump” above the knee (stifle) remaining after an amputation procedure. The right rear leg hip panel, like the left rear leg hip panel, has a pocket on the inside for the “stump” to slide into. The pocket is constructed of a stretchable, breathable neoprene to provide a comfortable fit. The top inside of the pocket has a band of stretchable elastic lined with a soft material to allow a range of leg circumferences to fit in the pocket without any rubbing irritation to the leg. The single pouch strap mentioned above is used to wrap around the inside of the leg stump and then attaches to the right rear leg hip panel to secure the right rear leg hip panel to the right rear leg stump of the four-legged animal. The pouch strap may be used to secure anywhere on the right rear leg hip panel to provide a customized fit. The right rear leg hip panel then attaches to a left rear leg hip panel over the pelvis so that the hip brace system is secure on the pet/four-legged animal. The right rear leg hip panel has a panel tether that extends transversely from the right rear leg hip panel and slides through the D-ring or other loop of the pet harness and then attaches to itself. As previously mentioned, the panel tether is made of a weave or non-weave material such as, for example, nylon webbing, leather, and the like. This feature aides in securing the hip brace system in place and allows for length adjustment and to position the base support component directly over the pelvis. As previously stated, it should be noted that the panel tether could be attached to the left rear leg hip panel instead of the right rear leg hip panel to accomplish the same feature.

The cross brace assembly is adapted to keep pets and other four-legged animals from crossing their rear legs because of hind leg weakness. Pets suffering from hind leg weakness caused by neurological diseases, strokes, spinal compression, and post-surgical procedures may be affected by rear leg crossing. The cross brace assembly includes a tubular shaped sleeve that adjusts in length. A round, firm foam piece is inserted into a pocket formed by the sleeve. The sleeve is then closed to secure the foam piece within the pocket of the cross brace assembly. In one aspect of the cross brace assembly, there are snaps lining the left and right front of a sleeve closure flap. These are used to adjust the length of the sleeve based on the width between a four-legged animal's rear legs. A sleeve strap such as, for example, nylon webbing, is sewn onto each end of the sleeve or onto the respective leg brace strap. The sleeve strap has a mating fastener, which, in the case where snaps are used, a mating snap. The fastener on the sleeve strap connects to a mating fastener on the sleeve closure flap of the sleeve to set a length of the brace sleeve. Any excess sleeve is tucked into each end before fastening the sleeve strap to the sleeve. One stretchable leg brace strap is attached to each end of the sleeve. With the fasteners on the assembled brace sleeve facing downward, the cross brace assembly is then placed directly in between the inner thighs or rear legs of a pet. The stretchable straps then wrap around the left and right leg accordingly and attach to the rear leg hip panel on each leg. The cross brace assembly prevents the four-legged animal from crossing its rear legs by keeping the rear legs apart.

In one embodiment of the present invention, the animal hip brace system includes a forward harness attachable to a four-legged animal, a right rear leg hip panel, a right leg strap connected to a right panel distal end and capable of encircling a right rear leg, a left rear leg hip panel complementary to the right rear leg hip panel, a left leg strap connected to a left panel distal end and capable of encircling a left rear leg, a panel tether between the forward harness and one of a right panel proximal end and a left panel proximal end, and at least one of a hip bridge and a hip donut where each of the hip bridge and the hip donut is removably attachable to one of a right panel inner surface and a left panel inner surface of the respective rear leg hip panels.

In another embodiment, the system further includes a cross brace assembly that is positioned between the rear legs of the four-legged animal. The cross brace assembly has a brace sleeve with a first cross brace end, a second cross brace end, a right leg brace strap transversely connected to the first cross brace end, and a left leg brace strap transversely connected to the second cross brace end where each of the right leg brace strap and the left leg brace strap is capable of encircling a respective rear leg of the four-legged animal. It should be understood that the right leg brace strap and the left leg brace strap are parallel to each other with the brace sleeve positioned between the right and left leg brace strap.

In another aspect of the present invention, the cross brace assembly includes a brace insert and a fabric brace sleeve that contains the brace insert. The brace insert is made of a foam material, preferably a foam cylinder but may have any other cross-sectional shape.

In a further aspect, at least one of the right leg brace strap and the left leg brace strap has a sleeve strap transversely connected to the at least one of the right leg brace strap and the left leg brace strap. The right and left leg brace strap is adapted for removable connection to the right and left rear leg hip panel.

In another embodiment, the system further includes a right rear leg hip panel having a right panel inner surface, a right panel proximal end, a right panel distal end, and a right panel pouch formed on the right panel inner surface adjacent the right panel distal end. The right panel pouch is adapted for receiving and supporting a stump portion of an amputated right rear leg.

In another aspect, the right rear leg hip panel having the right panel pouch includes a panel pouch strap connected to the right panel distal end and capable of encircling the stump portion of the amputated right rear leg of the four-legged animal.

In another embodiment, the system further includes a left rear leg hip panel having a left panel inner surface, a left panel proximal end, a left panel distal end, and a left panel pouch formed on the left panel inner surface adjacent the left panel distal end. The left panel pouch is adapted for receiving and supporting a stump portion of an amputated left rear leg.

In another aspect, the left rear leg hip panel with the left panel pouch includes a panel pouch strap connected to the left panel distal end and capable of encircling the stump portion of the amputated left rear leg of the four-legged animal.

In another embodiment, the panel tether is fixedly attached to either the right rear leg hip panel adjacent to the right panel proximal end or the left rear leg hip panel adjacent to the left panel proximal end.

In another embodiment, a method for supporting the hips of a four-legged animal is disclosed. The method includes attaching a forward harness to a four-legged animal, attaching one of a hip bridge or a hip donut to at least one of a right panel inner surface of a right rear leg hip panel spaced from a right panel proximal end or a left panel inner surface of a left rear leg hip panel spaced from a left panel proximal end where the left rear leg panel is complementary to the right rear leg hip panel, attaching the right rear leg hip panel to a right rear leg and against a right hip of the four-legged animal, attaching the left rear leg hip panel to a left rear leg and against a left hip of the four-legged animal where the one of the right rear leg panel and the left rear leg panel having the hip bridge or the hip donut is positioned such that the hip bridge or the hip donut is over a hip joint of the four-legged animal, connecting a right panel proximal end of the right rear leg hip panel to a left panel proximal end of the left rear leg hip panel where the respective hip bridge or the hip donut is positioned over the hip joint such that a respective bridge recess or a donut opening is over the hip joint, and connecting a panel tether between the forward harness and at least one of the right rear leg hip panel and the left rear leg hip panel to thereby provide pressure and support to the hip joint.

In another aspect of the method, the step of attaching the right rear leg hip panel to the right rear leg includes connecting a right leg strap to a right panel distal end of the right rear leg hip panel and encircling the right leg of the four-legged animal with the right leg strap to secure the right panel distal end to the right rear leg.

In another aspect of the method, the step of attaching the left rear leg hip panel to the left rear leg includes connecting a left leg strap to a left panel distal end of the left rear leg hip panel and encircling the left leg of the four-legged animal with the left leg strap to secure the left panel distal end to the left rear leg.

In another aspect of the method, the method further includes attaching a cross brace assembly between the right rear leg and the left rear leg of the four-legged animal and securing a right leg brace strap and a left leg brace strap of the cross brace assembly to the respective right panel distal end and the left panel distal end.

In another embodiment, a method for supporting the hips of a four-legged animal having one of the rear legs partially amputated is disclosed. The method includes attaching a forward harness to a four-legged animal, obtaining one of a right rear leg hip panel without a right panel pouch or a right rear leg hip panel having a right panel pouch for supporting a stump of an amputated right rear leg when the right rear leg is an amputated leg, obtaining one of a left rear leg hip panel without a left panel pouch or a left rear leg hip panel having a left panel pouch for supporting a stump of an amputated left rear leg when the left rear leg is the amputated leg, attaching one of a hip bridge or a hip donut to at least one of a right panel inner surface of a right rear leg hip panel spaced from a right panel proximal end or to a left panel inner surface of a left rear leg hip panel spaced from a left panel proximal end, attaching the right rear leg hip panel to a right rear leg and against a right hip of the four-legged animal when the right rear leg is not the amputated leg or inserting the stump of the amputated right rear leg into the right panel pouch of the right rear leg hip panel and against the right hip of the four-legged animal, attaching the left rear leg hip panel to a left rear leg and against a left hip of the four-legged animal when the left rear leg is not the amputated leg or inserting the stump of the amputated left rear leg into the left panel pouch of the left rear leg hip panel and against the left hip of the four-legged animal, connecting one of a right panel proximal end of the right rear leg hip panel to a left panel proximal end of the left rear leg hip panel, such that the one of the right rear leg panel and the left rear leg panel having the hip bridge or the hip donut is positioned such that the hip bridge or the hip donut is over the respective hip joint of the four-legged animal, and connecting a panel tether between the forward harness and at least one of the right rear leg hip panel and the left rear leg hip panel such that the right panel proximal end and the left panel proximal end are positioned over the pelvis of the four-legged animal.

In another aspect of the method, the step of attaching the right rear leg hip panel to the right rear leg includes connecting a right leg strap to a right panel distal end of the right rear leg hip panel and encircling the right leg of the four-legged animal with the right leg strap to secure the right panel distal end to the right rear leg.

In another aspect of the method, the step of attaching the left rear leg hip panel to the left rear leg includes connecting a left leg strap to a left panel distal end of the left rear leg hip panel and encircling the left leg of the four-legged animal with the left leg strap to secure the left panel distal end to the left rear leg.

In another aspect of the method, the step of attaching the right rear leg hip panel to an amputated right rear leg includes connecting a panel pouch strap to the right panel distal end of the right rear leg hip panel and encircling the stump of the right rear leg of the four-legged animal with panel pouch strap to secure the right panel distal end to the stump of the right rear leg.

In another aspect of the method, the step of attaching the left rear leg hip panel to an amputated left rear leg includes connecting a panel pouch strap to the left panel distal end of the left rear leg hip panel and encircling the stump of the left rear leg of the four-legged animal with panel pouch strap to secure the left panel distal end to the stump of the amputated left rear leg.

In another aspect of the method, the method further includes attaching a cross brace assembly between the right rear leg and the left rear leg of the four-legged animal and securing the cross brace assembly to the respective right panel distal end and the left panel distal end.

### BRIEF DESCRIPTION OF THE DRAWINGS

FIG. 1 is right side perspective view of an embodiment of the present invention as applied to a four-legged animal.

FIG. 2 is right side view of the embodiment in FIG. 1.

FIG. 3 is a left side view of the embodiment in FIG. 1.

FIG. 4 is a left side perspective view of another embodiment of the present invention showing a hip panel with a pouch as applied to a four-legged animal with a rear leg stump.

FIG. 5 is a right side perspective view of the hip panels of the embodiment in FIG. 1 showing one embodiment of a rear leg strap.

FIG. 6 is a left side perspective view of the hip panels of the embodiment in FIG. 1.

FIG. 7 is a perspective view of a right rear leg hip panel of the embodiment in FIG. 4 showing the outer surface of the panel and a panel pouch strap.

FIG. 8 is a perspective view of the right rear leg hip panel of the embodiment in FIG. 7 showing the inner surface of the panel with a pouch.

FIG. 9 is a perspective view of another embodiment of a left rear leg hip panel showing the inner surface of the panel with a pouch.

FIG. 10 is a perspective view of another embodiment of a left rear leg hip panel of the embodiment in FIG. 9 for a leg stump showing the outer surface of the panel.

FIG. 11 is a right side view of another embodiment of the rear hip panels showing one embodiment of a hip bridge.

FIG. 12 is an enlarged view of the hip panel of FIG. 11 showing placement of the hip bridge relative to the hip joint.

FIG. 13 is a left side view of another embodiment of the rear hip panels showing one embodiment of a hip donut.

FIG. 14 is an enlarged view of the hip panel of FIG. 13 showing placement of the hip donut relative to the hip joint.

FIG. 15 is a perspective view of the hip bridge of FIG. 11.

FIG. 16 is a front view of the hip bridge of FIG. 15.

FIG. 17 is a rear view of the hip bridge of FIG. 15.

FIG. 18 is a perspective view of the hip donut of FIG. 13.

FIG. 19 is a front view of the hip donut of FIG. 17.

FIG. 20 is a rear view of the hip donut of FIG. 17.

FIG. 21 is a right side perspective view showing one embodiment of a cross brace assembly positioned between the rear legs of a four-legged animal.

FIG. 22 is a rear view of FIG. 21.

FIG. 23 is an enlarge view of the area delineated by the circle in FIG. 22.

FIG. 24 is a perspective view of the cross brace assembly of FIG. 21.

FIG. 25 is a top view of the cross brace assembly of FIG. 24.

FIG. 26 is a bottom view of the cross brace assembly of FIG. 24.

FIG. 27 is a right side view of the cross brace assembly of FIG. 24.

FIG. 28 is a left side view of the cross brace assembly of FIG. 24.

FIG. 29 is a perspective view of the cross brace assembly of FIG. 24 showing the sleeve closure flap of the brace sleeve in a closed, secured position to the brace sleeve.

FIG. 30 is a perspective view of one embodiment of a cross brace insert of the cross brace assembly.

FIG. 31 is a side view of the cross brace insert of FIG. 30.

FIG. 32 is an end view of the cross brace insert of FIG. 30.

### DETAILED DESCRIPTION OF THE INVENTION

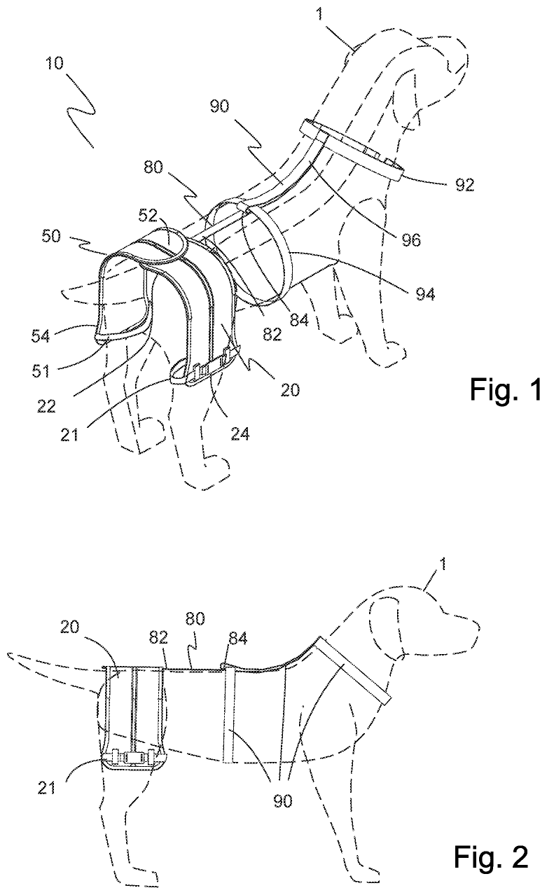

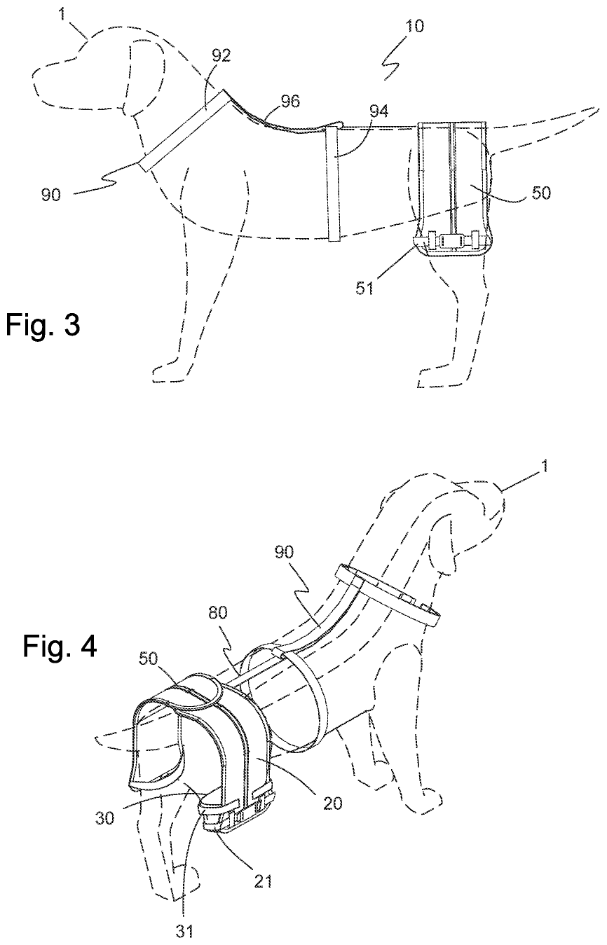

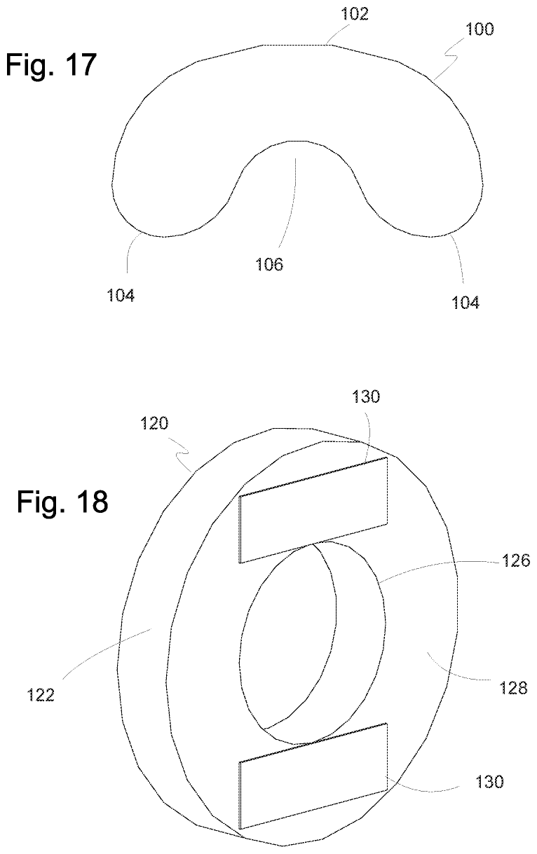

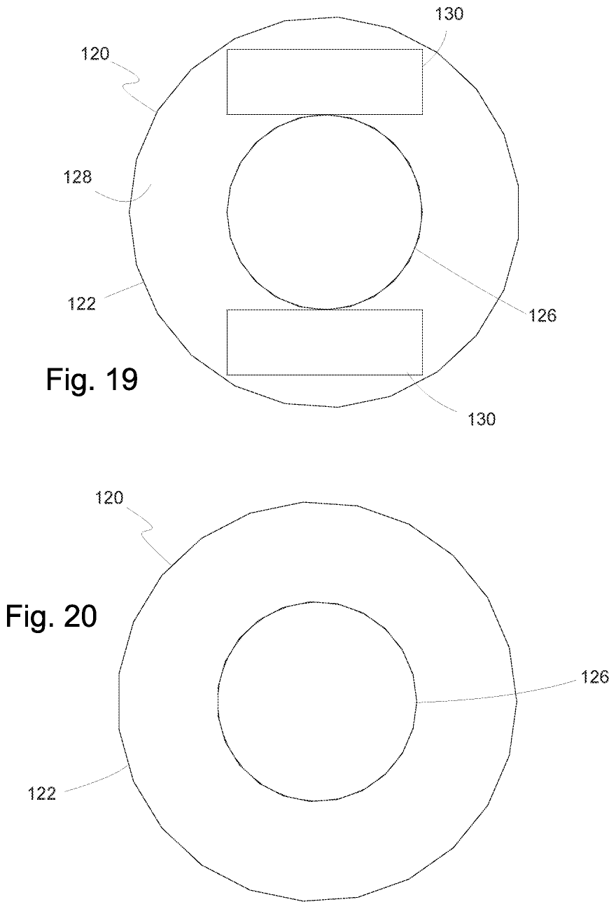

The present invention is illustrated in FIGS. 1-32. A four-legged animal hip brace system 10 is generally represented in FIGS. 1-3. The hip brace system 10 includes a right rear leg hip panel 20, a left rear leg hip panel 50 that is complementary to the right rear leg hip panel 20, and a forward harness 90. The right rear leg hip panel 20 includes a right leg strap 21 and the left rear leg hip panel 50 includes a left leg strap 51. It is noted that right and left leg straps 21, 51 are interchangeable with each of the hip panels 20, 50. The right rear leg hip panel 20 has a right panel proximal end 22 and a right panel distal end 24. The left leg hip panel 50 has a left panel proximal end 52 and a left panel distal end 54. The right and left panel distal ends 24, 54 overlap and fasten to each other. Hook and loop fastener is typically used for easier adjustment (compared to other fastener types) at the right and left proximal panel ends 22, 52 such that the panel ends 22, 52 attach to each other on top of the pelvis of the four-legged animal. Right and left hip panels 20, 50 are made of a flexible material capable of conforming to the rear legs of the four-legged animal 1. An example of a useable material is a neoprene material and the like. The right and left distal ends 24, 54 of the right and left panels 20, 50 are secured to the respective rear leg of the four-legged animal 1 by the right and left leg straps 21, 51, respectively, above the stifle (i.e. knee) on each respective leg. Right and left leg straps 21, 51 are typically made of a webbing material, such as, for example, nylon webbing, for comfort, although other flexible materials may also be used such as, for example, leather, plastic, felt, etc.

Also included is a panel tether 80 that connects one of the right or left panel proximal ends 22, 52 of hip panels 20, 50 to forward harness 90. In the illustrated embodiment, panel tether 80 is secured at a tether panel end 82 to right panel proximal end 22 and at a tether harness end 84 to forward harness 90. Tether panel end 82 may be fixedly or removably attached to right panel proximal end 22 and tether harness end 84 may be fixedly or removably attached to forward harness 90. However, at least one of tether panel ends 82, 84 is removably attachable in order to allow for adjustment between hip panels 20, 50 and forward harness 90. Typically, the removable end of panel tether 80 has hook and loop fastener to easily connect to itself, however, other types of fasteners may be used to accomplish the function such as snaps, buttons, lacing, belt and buckle, and the like. The removable end is typically looped through a D-ring or other loop structure for adjustment between hip panels 20, 50 and forward harness 90. Panel tether 80 is typically a flexible strap material such as previously disclosed for right and left leg straps 21, 51.

Forward harness 90 includes a harness neck strap 92, a harness torso strap 94 and a harness back strap 96 that connects between harness neck strap 92 and harness torso strap 94. At least one end of harness back strap 96 is removably connected to harness neck strap 92 or harness torso strap 94 to allow adjustment of the distance between harness neck strap 92 and harness torso strap 94 depending on the size of the four-legged animal 1.

Turning now to FIG. 4, there is illustrated another aspect of the hip brace system 10. The main difference in this embodiment is that right rear leg hip panel 20 includes a right panel pouch 30 formed on a right panel inner surface 28 adjacent right panel distal end 24. This feature is provided for four-legged animals 1 that have the right rear leg amputated above the stifle due to injury or disease. Right panel pouch 30 receives the stump of the amputated right leg of the four-legged animal. In addition to right leg strap 21, there is an optional right panel pouch strap 31 that also removably connects to right panel distal end 24 by encircling the stump and removably attaching to appropriate fastening mechanism disposed on right panel outer surface 26.

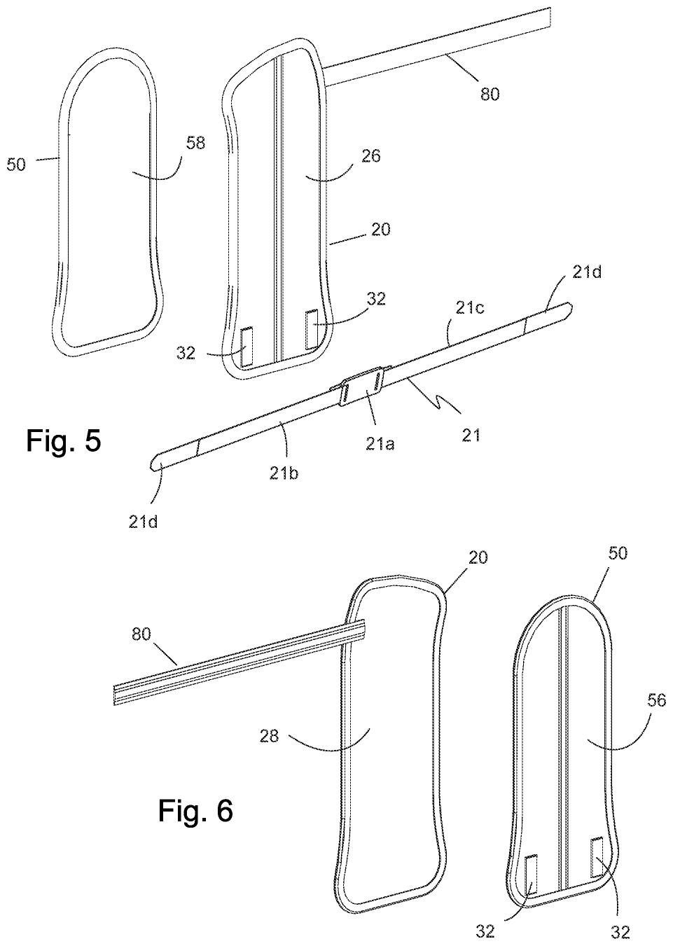

FIGS. 5 and 6 illustrate perspective views of right and left rear hip panels 20, 50 and leg strap 21. Each of the right and left panel outer surface 26, 56 has an outer surface strap fastener 32 affixed thereto and adjacent the respective right and left panel distal ends 24, 54. Right and left leg straps 21, 51 may be made of a single piece of a stretchable and flexible material with hook and loop fastener 21d fixedly attached at each end of right and left leg straps 21, 51. In the embodiment shown, right leg strap 21 is an assembly having a center link 21a, a first strap portion 21b connected on one end to the center link 21a and a second strap portion 21c connected on one end to an opposite side of the center link 21a. Each of the first and second strap portions 21b, 21c encircle the animal's leg so that center link 21a is against right panel outer surface 26 more or less central adjacent to the right panel proximal end 22 and first and second strap portions 21b, 21c criss-cross at the inside of the animal's leg and attaches to the outer surface strap fastener 32. As more clearly shown in FIG. 1, right panel proximal end 22 is against the top of the four-legged animal's pelvis and left panel proximal end 52 overlaps over right panel proximal end 22, which are fastened to each other, such that left panel inner surface 58 is facing right panel outer surface 26. Panel tether 80 extends transversely from right rear leg hip panel 20 adjacent to right panel proximal end 22. As previously disclosed, panel tether 80 allows adjustment of the hip brace so that right and left panel proximal ends are on top of the animal's pelvis and panel tether 80 is positioned parallel to the animal's spine. Typically, the fastener used to join the right and left panel proximal ends 22, 52 to each other is a hook and loop fastener system, which allows for more accurate and incremental adjustment. It is contemplated that the right rear leg hip panel 21 may have the structural design and features of the left rear leg hip panel 50 and, in such a case, the left rear leg hip panel 50 would have the structural design and features of right rear leg hip panel 20.

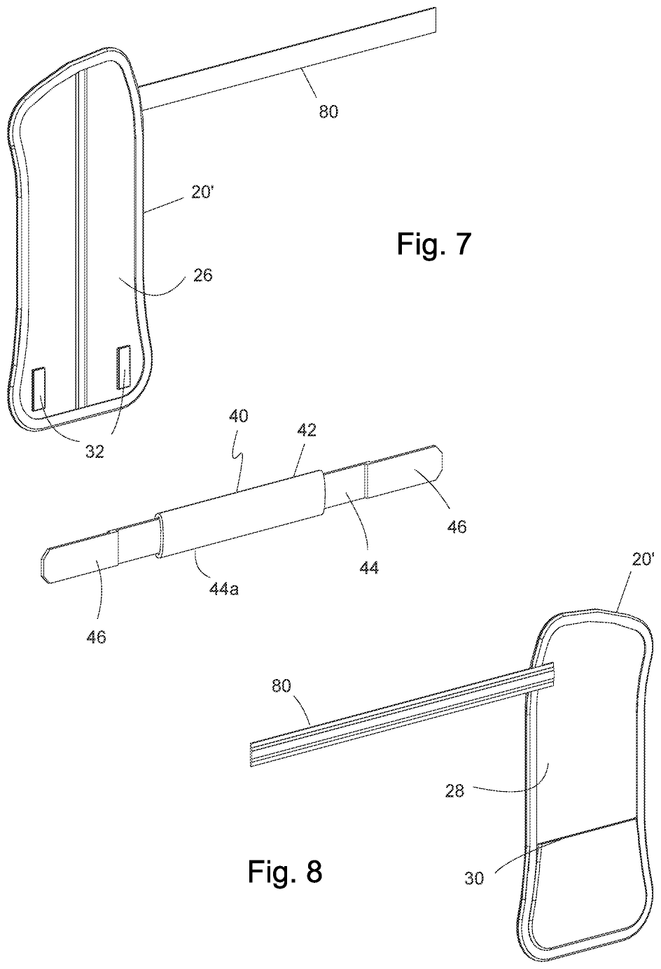

FIGS. 7 and 8 are outer and inner surface perspective views of another embodiment of right rear leg hip panel 20′. This embodiment is very much like right rear leg hip panel 20 except that there is a right panel pouch 30 formed on the right panel inner surface 28 at right panel distal end 24. Right panel pouch 30 typically has a depth in the range of about 4 to 6 inches (about 10 cm to 15.2 cm) to accommodate the stump of the amputated leg. Both right rear leg hip panels 20, 20′ have an average length of approximately 15 inches (about 38.1 cm) and a width of approximately 7 inches (about 17.75 cm), which flares out to about 8 inches (about 20.3 cm) at the right panel distal end 24. One embodiment of a panel pouch strap 40 is illustrated. In this embodiment, a tubular sleeve 42 surrounds an elastic cloth strap 44 about the stap's middle portion 44a with each strap end 46 typically being a hook and loop fastener. The tubular sleeve 42 is typically a foam-backed cloth stitched to form the tubular sleeve 42, which then slides over strap 44.

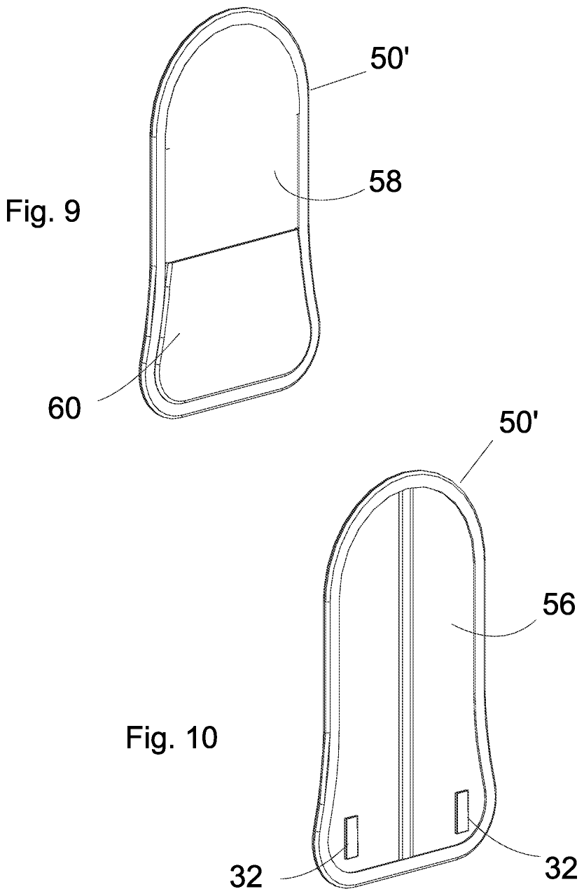

FIGS. 9 and 10 are inner and outer surface perspective views of another embodiment of left rear leg hip panel 50′. This embodiment is very much like left rear leg hip panel 50 except that there is a left panel pouch 60 formed on the left panel inner surface 58 at left panel distal end 54. Left panel pouch 60 typically has a depth in the range of about 4 to 6 inches (about 10 cm to 15.2 cm) to accommodate the stump of the amputated leg. Both left rear leg hip panels 50, 50′ have an average length of approximately 13 inches and a width of approximately 7 inches (about 33 cm), which flares out to about 8 inches (about 20.3 cm) at the left panel distal end 54. In both right and left rear leg hip panels 20′, 50′, the pouch 30, 60 is typically made of a stretchable, breathable material such as, for example, neoprene for a comfortable fit. The top inside of each pocket 30, 60 has a band of stretchable elastic lined with a soft material to allow for a range of leg circumferences to fit in pocket 30, 60.

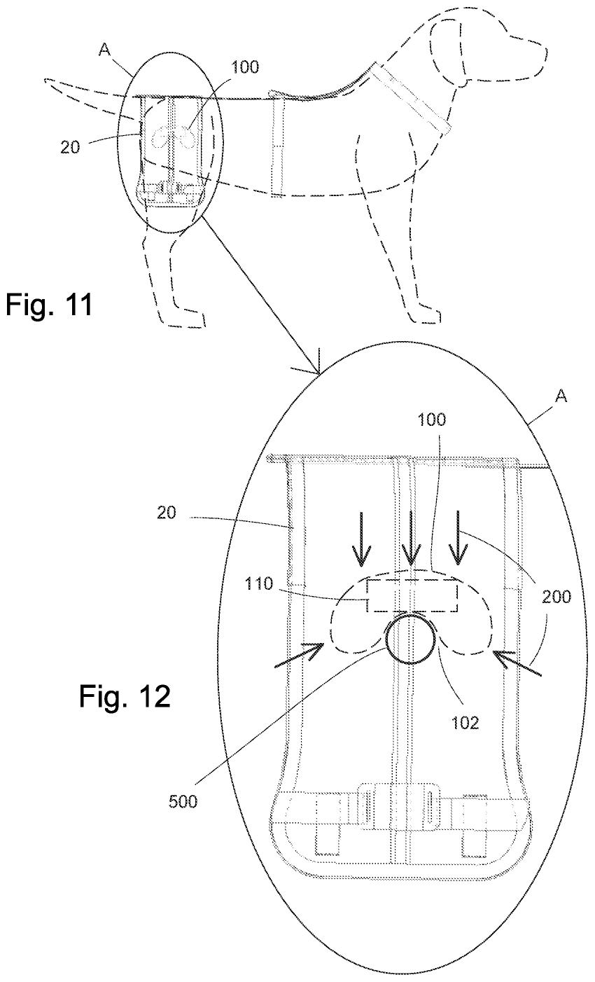

Turning now to FIGS. 11 and 12, there is illustrated another aspect of the hip brace system 10. In this embodiment, a hip bridge 100 is removably attached to right or left panel inner surface 28, 58, depending on which hip the four-legged animal is having particular issues. FIG. 12 is an enlarge view of the area delineated by the ellipse A in FIG. 11. As can be seen, hip bridge 100 is removably attached to the hip panel so that the femoral head 500 of the hip joint of the four-legged animal 1 is situated within a bridge recess 102. When the leg panel, in this example, the right rear leg hip panel 20, is secured into position with left rear leg hip panel 50 and connected to forward harness 90, compression on the femoral head 500 is directed in three directions represented by arrows 200. For custom placement, a self-adhesive hook and loop fastener 110 is attached to hip bridge 100. The pressure on the femoral head 500 caused by the compression aides in keeping the coxo-femoral joint from subluxating out of place when the four-legged animal is standing or moving. Hip bridge 100 is an aide for four-legged animals suffering from mild to moderate hip subluxations.

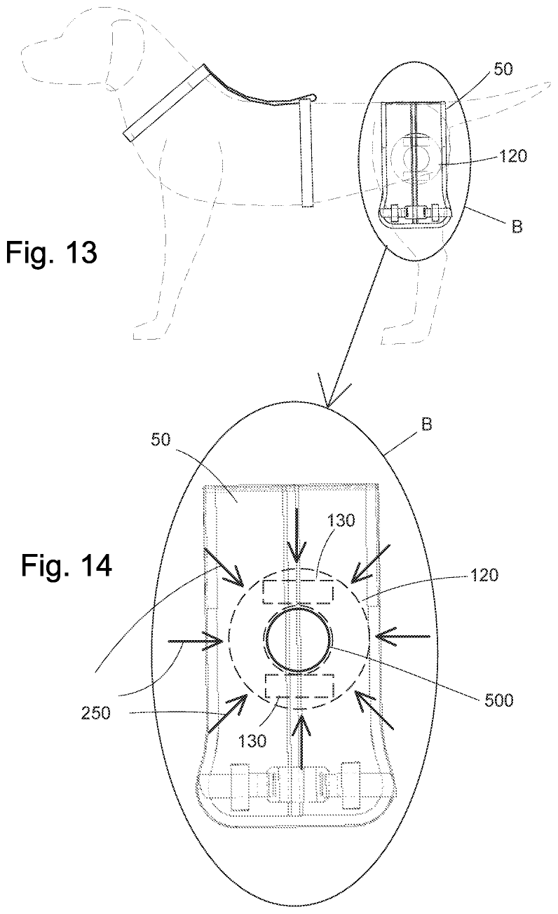

FIGS. 13 and 14 illustrate another aspect of the hip brace system 10. In this embodiment, a hip donut 120 is removably attached to right or left panel inner surface 28, 58, depending on which hip the four-legged animal is having particular issues. FIG. 12 is an enlarge view of the area delineated by the ellipse B in FIG. 13. As can be seen, hip donut 120 is removably attached to the hip panel so that the femoral head 500 of the hip joint of the four-legged animal 1 is situated within the donut opening 122, i.e. the donut hole. When the leg panel, in this example, the left rear leg hip panel 50, is secured into position with right rear leg hip panel 20 and connected to forward harness 90, hip donut 120 supports all around the coxo-femoral joint as represented by arrows 250 to thereby decrease pressure on the hip joint. Hip donut 120 prevents pressure and weight from being distributed directly onto the hip joint when the four-legged animal is in a lying down position. For custom placement, a self-adhesive hook and loop fastener 110 is attached to hip donut 120.

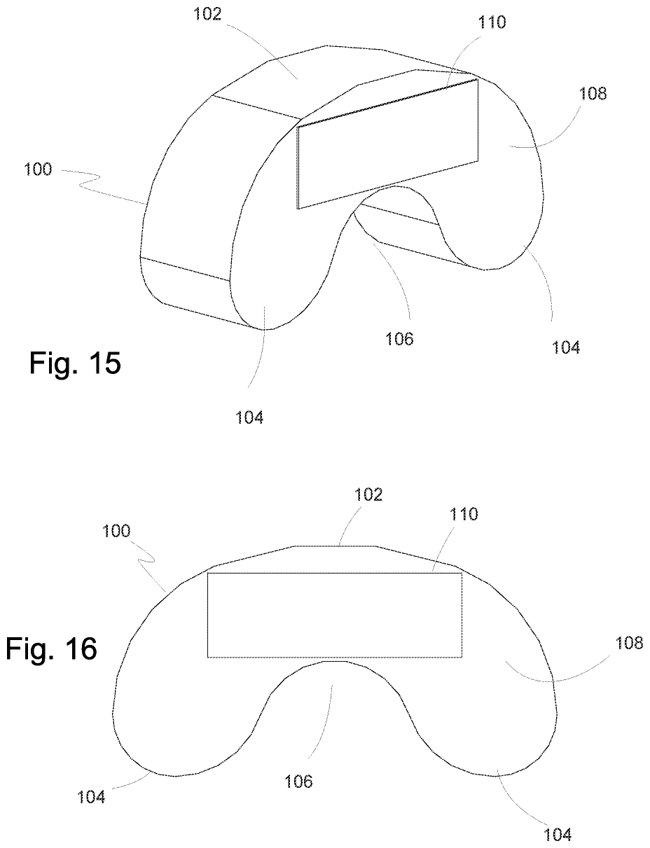

FIGS. 15, 16 and 17 illustrate one embodiment of hip bridge 100. As shown, hip bridge 100 has a bridge body 102 and extending lobes 104 extending from each end of bridge body 102 forming bridge recess 106. Bridge body 102 has an arcuate shape and a strip of hook fastener 110 fixedly secured to a bridge front surface 108. It is contemplated that hip bridge 100 may have any shape so long as there exists an open edge with a recess 106. Hip bridge 100 is made of a foam material and shaped to conform directly over the hip joint of the four-legged animal 1.

FIGS. 18, 19 and 20 illustrate one embodiment of hip donut 120. As shown, hip donut 120 has a donut body 122 forming donut opening 126. Donut body 122 has circular shape and a strip of hook fastener 130 fixedly secured to a donut front surface 128, typically in two positions opposite one another from donut opening 126. It is contemplated that hip donut 120 may have any shape so long as there exists a donut opening 126 for the hip joint. Hip donut 120 is made of a foam material and shaped to conform completely around the hip joint of the four-legged animal 1.

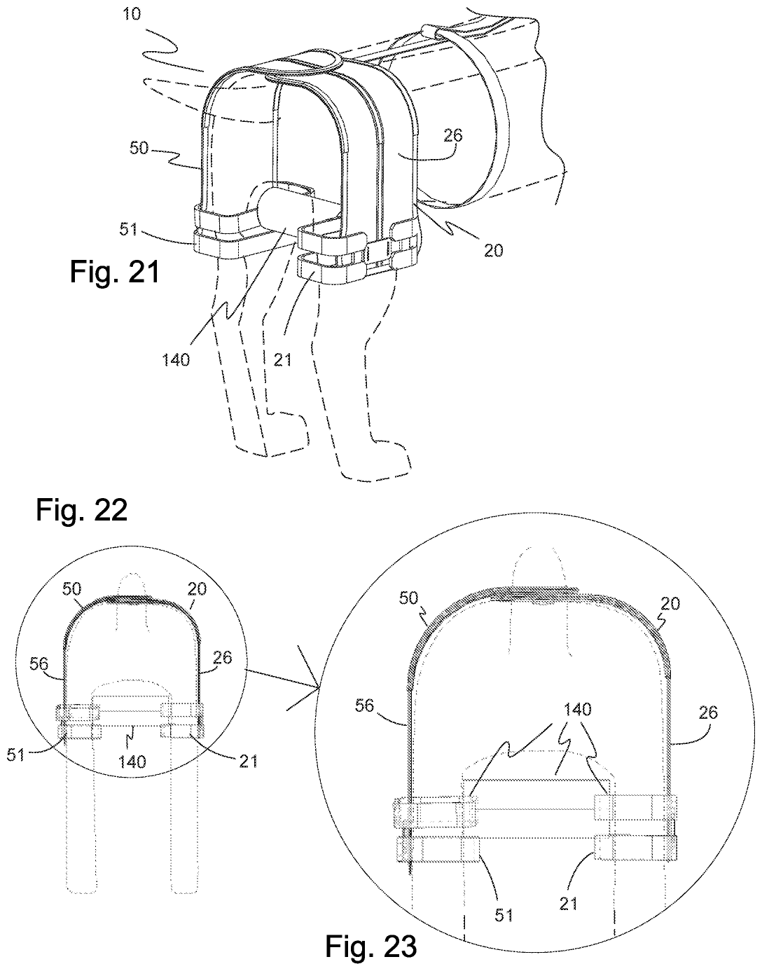

FIGS. 21, 22 and 23 illustrate another aspect of the hip brace assembly 10 showing a perspective view, a rear view and an enlarged rear view, respectively. Hip brace assembly further includes an optional cross brace assembly 140. In one embodiment and as illustrated, cross brace assembly 140 is designed to keep a four-legged animal from crossing its hind/rear legs. Four-legged animals suffering from rear leg weakness, which may be caused by neurological diseases, stroke, spinal compression, post-surgical procedures, and the like, may be affected by rear leg crossing. As illustrated, cross brace assembly 140 is positioned between the inner thighs or rear legs and removably attached to right and left panel outside surfaces 26, 56. Typically, cross brace assembly 140 is attached to right and left rear leg hip panels 20, 50 above the attachment locations of right and left leg straps 21, 51.

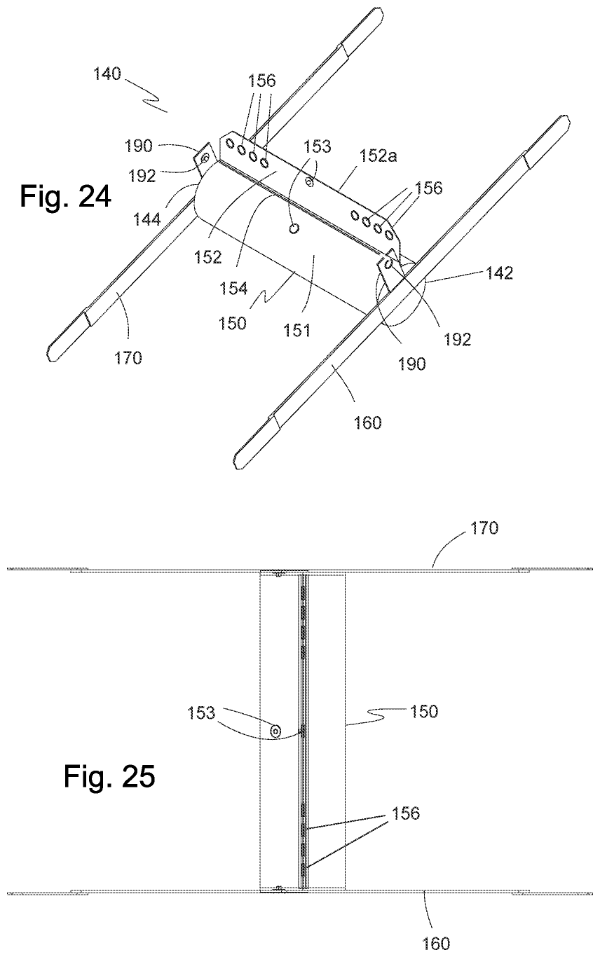

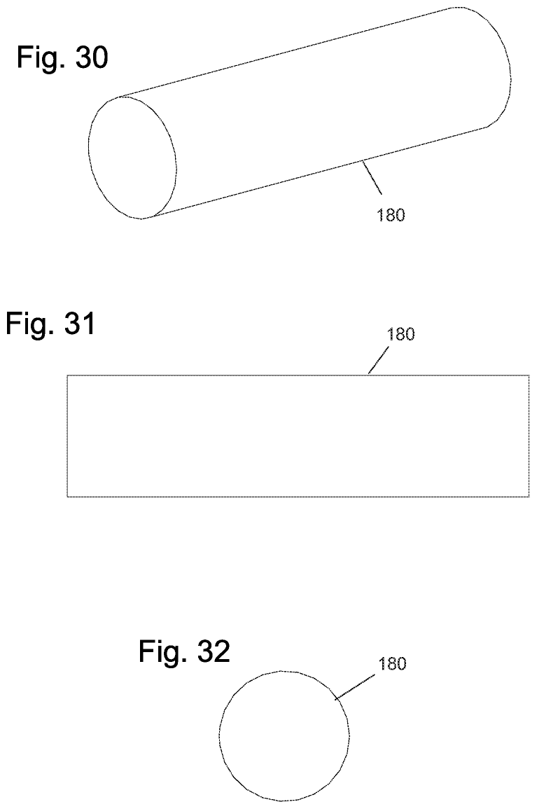

FIG. 24 is a perspective view of cross brace assembly 140. Cross brace assembly 140 generally includes a first cross brace end 142, a second cross brace end 144, a right leg brace strap 160 transversely connected to first cross brace end 142, and a left leg brace strap 170 transversely connected to second cross brace end 144 where each of right leg brace strap 160 and left leg brace strap 170 is capable of encircling a respective rear leg of the four-legged animal. More particularly, cross brass assembly 140 includes a brace sleeve 150, a right leg brace strap 160, a left leg brace strap 170, and a brace insert 180 (not shown but illustrated in FIGS. 30-32). Brace sleeve 150 includes a sleeve body 151, a sleeve closure flap 152 and a sleeve opening 154. Sleeve closure flap 152 and sleeve body 151 include a sleeve fastener 153 that matingly connects to each other when sleeve closure flap 152 is folded over to close sleeve opening, which is more clearly shown in FIG. 29.

Right leg brace strap 160 and left leg brace strap 170 include a sleeve strap 190 connected on one end to the respective brace strap 160, 170 at their approximate center and extend transversely from the brace strap. A mating sleeve strap fastener 192 is fixedly attached adjacent an opposite end of sleeve strap 190. Sleeve closure flap 152 includes a plurality of mating strap fasteners 156 disposed linearly longitudinally along sleeve closure flap 152 and spaced from closure flap edge 152a a predefined distance such that mating sleeve strap fastener 192 may matingly connect with one of the plurality of mating strap fasteners 156. The plurality of mating strap fasteners 156 provides the ability to set the length of brace sleeve 150 for adjusting the length of brace sleeve 150 based on the width between a four-legged animal's hind/rear legs. Any excess portion of the end of brace sleeve 150 is tucked into each end before matingly connecting mating sleeve strap fastener 192 to the respective one of the plurality of mating strap fasteners 156 on sleeve closure flap 152.

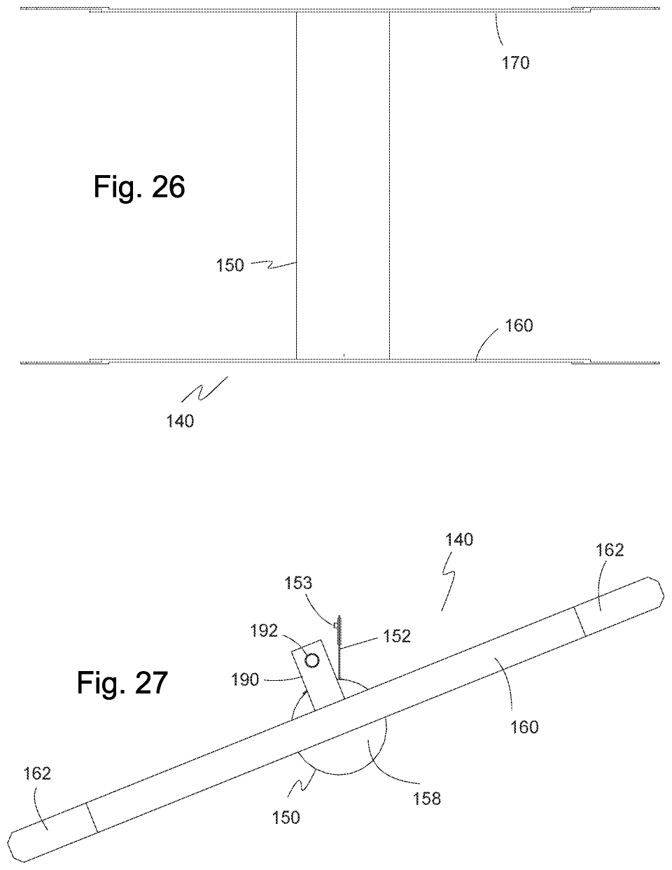

FIG. 25 is a top view of cross brace assembly 140 of FIG. 24 with sleeve closure flap 152 extending out of the plane of the drawing toward the viewer. In this embodiment, sleeve fastener 153 is positioned approximately equidistant from right and left leg brace straps 160, 170. FIG. 26 is a bottom view of cross brass assembly 140 in FIG. 25.

FIG. 27 illustrates a right side view of cross brace assembly 140. Right leg brace strap 160 is fixedly attached to a sleeve end closure 158 of brace sleeve 150. Right leg brace strap 160 has right end fastener portions 162 for removably attaching right leg brace strap 160 to right rear leg hip panel 20. Right end fastener portions 162 may be any known methods of attaching a strap to a flexible panel. Typically a hook and loop fastener system is used due to its ability to be easily adjusted depending on the width of the foul-legged animal's hind/rear leg.

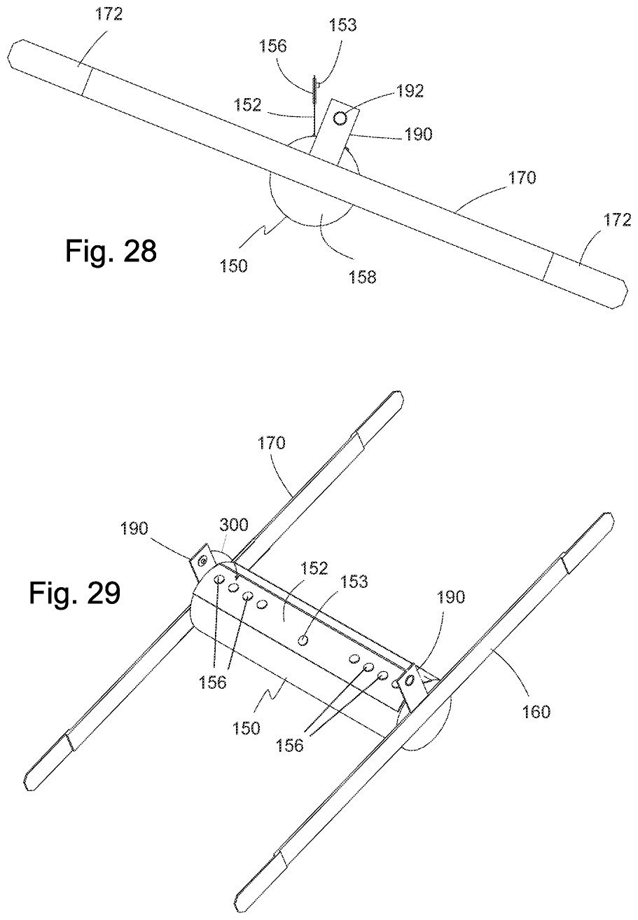

FIG. 28 illustrates a left side view of cross brace assembly 140. Left leg brace strap 170 is fixedly attached to a sleeve end closure 158 of brace sleeve 150. Left leg brace strap 170 has left end fastener portions 172 for removably attaching left leg brace strap 170 to left rear leg hip panel 50. Left end fastener portions 172 may be any known methods of attaching a strap to a flexible panel. Typically, a hook and loop fastener system is used due to its ability to be easily adjusted depending on the width of the foul-legged animal's hind/rear leg.

FIG. 29 is a perspective view of FIG. 24 but with sleeve closure flap 152 in a closed position. Once brace insert 180 is positioned within brace sleeve 150, sleeve closure flap 152 is folded over toward brace sleeve 150 to cover sleeve opening 154. Sleeve fasteners 153 on brace sleeve 150 and sleeve closure flap 152 are connected to each other to thereby maintain brace sleeve 150 in a closed position. Arrow 300 indicates the direction that sleeve strap 190 is folded toward brace sleeve 150 and sleeve closure flap 152. As previously mentioned, depending on the require length of brace sleeve 150 to fit the four-legged animal's distance between the rear legs, mating sleeve strap fastener 192 is attached to the appropriate mating strap fastener 156 on sleeve closure flap 152.

FIGS. 30, 31 and 32 illustrate one embodiment of a brace insert 180. Brace insert 180 may be any shape but a cylindrical shaped insert is shown. Brace insert is made of a foam material and has a length typically in the range of 5 inches (about 12.7 cm) to 12 inches (about 30.5 cm) and a diameter in the range of 2 inches (about 5 cm) to 4 inches (about 10.2 cm), depending on the size of the four-legged animal. However, it is understood that the specific dimensions of any of the components of the hip brace system 10 are not limiting and that the dimensions are determined based on the size of the four-legged animal.

To use cross brace assembly 140, right rear leg hip panel 20, left rear leg hip panel 50 and forward harness 90 must be assembled onto the four-legged animal before attaching cross brace assembly 140. Before assembling cross brace assembly 140, a user must measure the distance between the rear thighs of the four-legged animal and then select the proper length brace insert 180. Brace insert 180 is then placed into brace sleeve 150 and sleeve closure flap 152 is folded over and fastened to brace sleeve 150. Any excess sleeve end closure 158 is tucked into each end of brace sleeve 150. Sleeve strap 190 on each of right and left leg brace strap 160, 170 is folded over and then mating sleeve strap fastener 192 is connected to the appropriate mating strap fastener 156 on sleeve closure flap 152 to maintain the desired length of brace sleeve 150. Cross brace assembly 140 is then positioned between the rear thighs of the four-legged animal and each of right leg brace strap 160 and left leg brace strap 170 is wrapped around to the outside surface 26, 56 of the respective right and left rear leg hip panel 20, 50 and connected to the respective surface.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A four-legged animal hip brace system (10) comprising:
a forward harness (90) attachable to a four-legged animal (1);
a right rear leg hip panel (20) having a right panel inner surface (28), a right panel proximal end (22) and a right panel distal end (24);
a right leg strap (21) connected to the right panel distal end (24) and capable of encircling a right rear leg of the four-legged animal;
a left rear leg hip panel (50) complementary to the right rear leg hip panel (20), the left rear leg hip panel (50) having a left panel inner surface (58), a left panel proximal end (52) and a left panel distal end (54);
a left leg strap (51) connected to the left panel distal end (54) and capable of encircling a left rear leg of the four-legged animal;
a panel tether (80) between the forward harness (90) and one of the right panel proximal end (22) and the left panel proximal end (52); and
at least one of a hip bridge (100) and a hip donut (120) wherein each of the hip bridge (100) and the hip donut (120) is removably attachable to one of the right panel inner surface (28) and the left panel inner surface (58).

2. The system of claim 1 further comprising a cross brace assembly (140) having a first cross brace end (142), a second cross brace end (144), a right leg brace strap (160) transversely connected to the first cross brace end (142), and a left leg brace strap (170) transversely connected to the second cross brace end (144) wherein each of the right leg brace strap (160) and the left leg brace strap (170) is capable of encircling a respective rear leg of the four-legged animal.

3. The system of claim 2 wherein the cross brace assembly (140) includes a brace insert (180) and a brace sleeve (150) containing the cross brace insert.

4. The system of claim 2 wherein at least one of the right leg brace strap (160) and the left leg brace strap (170) has a sleeve strap (190) transversely connected to the at least one of the right leg brace strap (160) and the left leg brace strap (170), the sleeve strap (190) being removably connectable to a brace sleeve (150).

5. The system of claim 1 further wherein the right rear leg hip panel further includes a right panel pouch (30) formed on the right panel inner surface (28) adjacent the right panel distal end (24), the right panel pouch (30) adapted for receiving and supporting a stump portion of the right rear leg.

6. The system of claim 5 further comprising a panel pouch strap (40) connected to the right panel distal end (24) and capable of encircling the stump portion of the right rear leg of the four-legged animal.

7. The system of claim 1 further wherein the left rear leg hip panel (50) includes a left panel pouch (60) formed on the left panel inner surface (58) adjacent the left panel distal end (54), the left panel pouch (60) adapted for receiving and supporting a stump portion of the left rear leg.

8. The system of claim 7 further comprising a panel pouch strap (40) connected to the left panel distal end (54) and capable of encircling the stump portion of the left rear leg of the four-legged animal.

9. The system of claim 1 wherein the panel tether (80) is fixedly attached to the right rear leg hip panel (20) adjacent to the right panel proximal end (22).

10. The system of claim 1 wherein the panel tether (80) is fixedly attached to the left rear leg hip panel (50) adjacent to the left panel proximal end (52).

11. A method for supporting hips of a four-legged animal, the method comprising:
attaching a forward harness (90) to a four-legged animal (1);
attaching one of a hip bridge (100) or a hip donut (120) to one of a right panel inner surface (28) of a right rear leg hip panel (20) spaced from a right panel proximal end (22) or a left panel inner surface (58) of a left rear leg hip panel (50) spaced from a left panel proximal end (52) wherein the left rear leg panel (50) is complementary to the right rear leg hip panel (20);
attaching the right rear leg hip panel (20) to a right rear leg and against a right hip of the four-legged animal;
attaching the left rear leg hip panel (50) to a left rear leg and against a left hip of the four-legged animal wherein the one of the right rear leg panel (20) and the left rear leg panel (50) having the hip bridge (100) or the hip donut (120) is positioned such that the hip bridge (100) or the hip donut (120) is over a hip joint of the four-legged animal;
connecting a right panel proximal end (22) of the right rear leg hip panel (20) to a left panel proximal end (52) of the left rear leg hip panel (50) wherein the respective hip bridge (100) or the hip donut (120) applies pressure directly on a top of the hip joint and pushes inward on the joint; and
connecting a panel tether (80) between the forward harness (90) and at least one of the right rear leg hip panel (20) and the left rear leg hip panel (50).

12. The method of claim 11 wherein the step of attaching the right rear leg hip panel (20) to the right rear leg includes connecting a right leg strap (21) to a right panel distal end (24) of the right rear leg hip panel (20) and encircling the right leg of the four-legged animal with the right leg strap (21) to secure the right panel distal end (24) to the right rear leg.

13. The method of claim 11 wherein the step of attaching the left rear leg hip panel (50) to the left rear leg includes connecting a left leg strap (51) to a left panel distal end (54) of the left rear leg hip panel (50) and encircling the left leg of the four-legged animal with the left leg strap (51) to secure the left panel distal end (54) to the left rear leg.

14. The method of claim 11 further comprising attaching a cross brace assembly (140) between the right rear leg and the left rear leg of the four-legged animal and securing a first cross brace end (142) and a second cross brace end (144) of the cross brace assembly 140 to the respective right panel distal end (24) and the left panel distal end (54).

15. A method for supporting hips of a four-legged animal having one of the rear legs partially amputated, the method comprising:
attaching a forward harness (90) to a four-legged animal (1);
obtaining one of a right rear leg hip panel (20) without a right panel pouch (30) or with the right panel pouch (30) for supporting a stump of an amputated right rear leg;
obtaining one of a left rear leg hip panel (50) without a left panel pouch (60) or with the left panel pouch (60) for supporting a stump of an amputated left rear leg;
attaching one of a hip bridge (100) or a hip donut (120) to a right panel inner surface (28) of a right rear leg hip panel (20) spaced from a right panel proximal end (22) when the right rear leg is not an amputated leg or to a left panel inner surface (58) of a left rear leg hip panel (50) spaced from a left panel proximal end (52) when the left rear leg is not the amputated leg;
attaching the right rear leg hip panel (20) to a right rear leg and against a right hip of the four-legged animal when the right rear leg is not the amputated leg or inserting the stump of the amputated right rear leg into the right panel pouch (30) of the right rear leg hip panel (20) and against the right hip of the four-legged animal;
attaching the left rear leg hip panel (50) to a left rear leg and against a left hip of the four-legged animal when the left rear leg is not the amputated leg or inserting the stump of the amputated left rear leg into the left panel pouch (60) of the left rear leg hip panel (50) and against the left hip of the four-legged animal;
connecting one of a right panel proximal end (22) of the right rear leg hip panel (20) to a left panel proximal end (52) of the left rear leg hip panel (50) having a left panel pouch (60) when the left rear leg is the amputated leg or a right panel proximal end (22) of the right rear leg hip panel (20) having a right panel pouch (30) to the left panel proximal end (52) of the left rear leg hip panel (50) when the right rear leg is the amputated leg, such that the one of the right rear leg panel (20) and the left rear leg panel (50) having the hip bridge (100) or the hip donut (120) is positioned such that the hip bridge (100) or the hip donut (120) is over the respective hip joint of the four-legged animal wherein the respective hip bridge (100) or the hip donut (120) applies pressure directly on a top of the hip joint and pushes inward on the joint; and
connecting a panel tether (80) between the forward harness (90) and at least one of the right rear leg hip panel (20) and the left rear leg hip panel (50).

16. The method of claim 15 wherein the step of attaching the right rear leg hip panel (20) to the right rear leg includes connecting a right leg strap (20) to a right panel distal end (24) of the right rear leg hip panel (20) and encircling the right leg of the four-legged animal with the right leg strap (21) to secure the right panel distal end (24) to the right rear leg.

17. The method of claim 15 wherein the step of attaching the left rear leg hip panel (50) to the left rear leg includes connecting a left leg strap (51) to a left panel distal end (54) of the left rear leg hip panel (50) and encircling the left leg of the four-legged animal with the left leg strap (51) to secure the left panel distal end (54) to the left rear leg.

18. The method of claim 15 wherein the step of attaching the right rear leg hip panel (20) having the right panel pouch (30) to the right rear leg includes connecting a panel pouch strap (40) to the right panel distal end (24) of the right rear leg hip panel (20) and encircling the stump of the right rear leg of the four-legged animal with the panel pouch strap (40) to secure the right panel distal end (24) to the stump of the right rear leg.

19. The method of claim 15 wherein the step of attaching the left rear leg hip panel (50) having the left panel pouch (60) to the left rear leg includes connecting a panel pouch strap (40) to the left panel distal end (54) of the left rear leg hip panel (50) and encircling the stump of the left rear leg of the four-legged animal with the panel pouch strap (40) to secure the left panel distal end (54) to the stump of the left rear leg.

20. The method of claim 15 further comprising attaching a cross brace assembly (140) between the right rear leg and the left rear leg of the four-legged animal and securing a first cross brace end (142) and a second cross brace end (144) of the cross brace assembly (140) to the respective right panel distal end (24) and the left panel distal end (54).
